(19) United States
(12) Patent Application Publication
(10) Pub. No.: US 2011/0008469 A1
(43) Pub. Date: Jan. 13, 2011

(54) ANTIMICROBIAL COMPOSITION AND METHODS AND APPARATUS FOR USE THEREOF

(75) Inventor: Jose Barreto, North Fort Myers, FL (US)

Correspondence Address: HAHN LOESER & PARKS, LLP, One GOJO Plaza, Suite 300, AKRON, OH, 44311-1076, US

(73) Assignee: FLORIDA GULF COAST UNIVERSITY, Fort Myers, FL (US)

(21) Appl. No.: 12/833,510

(22) Filed: Jul. 9, 2010

Related U.S. Application Data
(60) Provisional application No. 61/224,308, filed on Jul. 9, 2009.

(51) Int. Cl. A01N 31/00; A01N 59/00; A01N 33/12; A01N 41/04; A01N 33/02; A01P 1/00

(52) U.S. Cl. 424/719; 514/724; 514/642; 514/578; 514/663

(57) ABSTRACT

There is presented an alkaline disinfectant in the form of a multi-component composition, with each component being relatively benign until mixed with the other components in a ready-to-use solution. The invention further relates to the use of the composition in a variety of applications and apparatus for mixing and dispensing thereof. Furthermore, the invention relates to the use of components that synergistically provide effective biocidal activity in a broad spectrum of organisms, including germs, molds, viruses, bacteria, bacteria spores, or other microbes or pathogens. The composition provides a chemical system that kills all known plants, animals and microbes by raising pH and rapidly, but indirectly, transporting hydroxide into cells by use of ammonia compounds and/or amine compounds as neutral transporters. The composition components synergistically operate together to provide a disinfecting/cleaning composition useful for many different applications.

### CROSS-REFERENCE TO RELATED APPLICATIONS

This patent application claims the benefit of U.S. Provisional Patent Application No. 61/224,308 filed Jul. 9, 2009, the disclosure of which is expressly incorporated by reference herein.

### GRANT REFERENCE

The research carried out in connection with this invention was supported in part by a grant from the Department of Defense and the Environmental Protection Agency [EM-83298201-1]. The Government has certain rights in the invention.

### FIELD OF THE INVENTION

The invention relates to antimicrobial compositions and methods and apparatus for effective use thereof. More particularly, the invention relates to antimicrobial compositions useful for a variety of purposes in cleaning and disinfection, and methods and apparatus for using and dispensing the compositions.

### BACKGROUND OF THE INVENTION

Antimicrobials are generally used to destroy or suppress the growth or reproduction of microbes such as bacteria, viruses and the like. Many commonly available germicides are too toxic, excessively persistent, or difficult to handle in certain applications. For example, germicides using ozone, bleach, ethylene oxide, and various other oxidizing or halogenating chemicals fit in this category. Such germicides use a harsh chemical toxicity to engender killing but, whenever biocides are used, a balance must be struck between reducing an infectious microbial hazard and the creation of a serious chemical hazard. Antimicrobial compounds may act on targeted microbes in a variety of ways. For example, the antimicrobial compound may alter the cell wall of a microbe, either by altering cell wall permeability or by altering cell wall synthesis and repair, to destroy the microbe. Other compounds may prevent DNA or protein synthesis to destroy the microbe. While there are numerous known antimicrobial compounds, and numerous known mechanisms by which antimicrobial compounds may function, such compounds have various deficiencies. There are many characteristics that can be relevant when trying to decide whether or not a particular compound is useful as an antimicrobial. Relevant factors may include the relative potency of the compound against a specific microbe or against a spectrum of microbes, and the relative selectivity of the antimicrobial activity of the compound in targeting microbes or pathogens. Other factors may relate to the compounds producing undue irritation to eyes or skin at levels required to impart germicidal properties. Some antimicrobial compounds can be dangerous to use at higher concentration levels, or may leave residues that can continue to cause physical implications in humans. There are also long-term concerns, including the likelihood that the microbe may develop resistance to the antimicrobial compound. Additionally, additional concerns may relate to the cost and commercial availability of the antimicrobial compound.

Disinfecting compositions are commercially important products and enjoy a wide field of utility in assisting in the disinfecting and cleaning of surfaces, such as for use in cleaning “hard surfaces”. Hard surfaces are countertops, walls, floors and other such surfaces, such as in the home in kitchens, bathrooms, etc, and in hospitals or the like, where cleaning and disinfecting of such surfaces is important. Various formulations of cleaning/disinfecting agents have been developed, but may not be as effective at disinfecting and cleaning as desired. There is thus a current and continuing need for cleaning/disinfecting products which are highly effective disinfectants, but leave a minimum of discernible residue and are easily used and produced inexpensively.

In some applications, the materials used in cleaning or purifying materials may have other deficiencies. In water treatment for example, compounds such as chlorine are commonly used, but are toxic, and therefore may cause potential problems. For example, chlorination for the disinfection of raw water may produce trihalomethanes (THM's), such as chloroform, which are carcinogenic. It has further been determined that chlorinated drinking water, when ingested by laboratory animals, has also shown signs of carcinogenic effects. Handling of the material is also hazardous, putting those working with it at risk. Other water treatment approaches are costly or less effective than desired.

Currently, there are also heightened concerns over the hazards produced by microbes and pathogens, including in relation to the potential of bioweapons engineering of microbes or pathogens that could be released to impact a population. Other concerns relate to the possible release of biohazardous materials by accident. Government entities have therefore begun steps of preparedness for handling such incidents should they arise. Sterilization after a biological weapon attack is problematic when using overly harsh sterilizing agents. Although such germicides will destroy pathogens, they also damage the environment, and can result in damage to sensitive electronic equipment, furnishings and documents, can corrode metals, and harm human health. As a consequence, most germicides have a narrow scope of use and/or require extensive training for safe deployment.

Accordingly, new antimicrobials and germicides, and new sources of antimicrobials are desired and are increasingly valuable. It would also be highly desirable to provide antimicrobial compositions that achieve the characteristics of providing broad spectrum antimicrobial activity, while minimizing eye or skin irritation or other harmful effects, and while providing desired cleaning efficacy.

### SUMMARY OF THE INVENTION

In general, this invention relates to an alkaline disinfectant in the form of a multi-component composition, with each component being relatively benign until mixed with the other components in a ready-to-use solution. The invention further relates to the use of the composition in a variety of applications and apparatus for mixing and dispensing thereof. Furthermore, the invention relates to the use of components that synergistically provide effective biocidal activity in a broad spectrum of organisms, including germs, molds, viruses, bacteria, bacteria spores, or other microbes or pathogens. The composition provides a chemical system that kills all known plants, animals and microbes by raising pH and rapidly, but indirectly, transporting hydroxide into cells by use of ammonia compounds and/or amine compounds as neutral transporters. The composition components synergistically operate together to provide a disinfecting/cleaning composition useful for many different applications. In an example, the composition comprises 1) ethanol, 2) cetylamine, 3) ammonia and 4) a pH greater than 9.

The germicide according to the invention has the following characteristics. Extreme lethality, with no pathogens remaining to cause infection. A broad spectrum of killing activity is provided, with rapid killing of pathogens. The germicide has a short persistence time, with no long term toxicity remaining, and also has “switchability, wherein chemical neutralization may be used as a switch to immediately deactivate the germicide. Further, as components have high vapor pressures, evaporation of several components after deployment of the biocide provides an “auto-switch”, so that after sterilization, no long term toxicity can occur. The germicide also is inexpensive, portable, storable, safe and easy to use. The germicide and methods and apparatus for dispensing provide a system, wherein multiple components are safely provided in a storable arrangement, and easily mixed and used to provide for extreme lethality of microbes and pathogens. In an example, a dispensing device design allows the components to be stored safely for long periods in a multi-compartment plastic cylinder. When use is desired, mechanical rupture of plastic membranes is followed by mixing to obtain the germicidal composition and activity. A method for the cleaning of hard surfaces comprises the steps of providing the components for preparing a germicidal composition as described above; selectively mixing the components just before deployment, diluting the mixed composition with up to about 500 parts by weight water; and contacting the diluted cleaning composition with a hard surface to thereby kill microbes or pathogens that may be on the surface.

It is therefore an object of the invention to provide a germicidal disinfectant which conforms to these requirements, which can be formulated as a storable concentrate, and can be selectively diluted to form an aqueous, ready-to-use solution. The invention includes both methods and compositions to achieve the desired results, as described, but is not limited to the various embodiments disclosed.

### BRIEF DESCRIPTION OF THE DRAWINGS

FIG. 1 is a graph representing the effects of ethanol in differing concentrations on test bed organisms;

FIG. 2 is a graph representing the effects of hexadecylamine in differing concentrations on test bed organisms;

FIG. 3 is a graph representing the effects of ammonia in differing concentrations on test bed organisms;

FIG. 4 is a graph representing the effects of differing pH on test bed organisms; and

FIG. 5 is a graph representing the killing efficacy of the composition according to an example of the invention and other killing agents.

FIG. 6 is a graph representing the killing efficacy of a composition according to an example of the invention with varying detergent materials.

FIG. 7 is a graph representing the killing efficacy of a composition according to an example of the invention with varying alcohol materials.

### DETAILED DESCRIPTION OF THE INVENTION

Turning to a first example according to the invention, the composition of the germicide comprises a synergistic combination of components that together utilize an inward flux of chemicals that immediately interferes with cell metabolism and viability. The composition uses multiple components and multiple mechanisms to achieve complete lethality of microbes and pathogens of various types, such as including germs, molds, viruses, bacteria, bacteria spores, or other microbes or pathogens. The composition generates chemical flux into such microbes and pathogens that is invariably lethal to the microbes and pathogens. Although there may be extremophile organisms, occupying certain rare environments on earth, are capable of resisting the killing mechanism engendered by the composition of the invention, these are not human pathogens. Further, by using longer, or more concentrated treatment, even these extremophiles can be effectively killed by the germicide.

In general, the germicidal composition of the invention is alkaline, and has at least three components which act synergistically to kill germs, microbes and pathogens, and the mechanism of action is generic and can kill various microbes and pathogens including bacteria, bacterial spores, molds, and viruses for example. As with other components as will be described, each is in very small concentrations in the mM range. The first component is a small amount of ammonia or another long chain detergent type material for example, in the mM range, and in an amount of between 5-40 weight percent for example relative to the other components. Other concentrations may be suitable depending on the application. In this example, ammonia can exist in two forms in water, free base ammonia (a gas solvated in liquid water; NH₃) and a protonated form, the ammonium ion (NH₄⁺). The free base ammonia (NH₃) is readily permeable through the plasma membrane of all living cells and the free base form is more prevalent above the pKa of 9.0. That is to say, above a pH of ˜9.0 the free base will predominate. If the external pH of a cell is raised above 9.0 (and maintained at that pH) the cell will eventually die because an alkaline flux will ensue, either hydroxide ions will enter the cell or hydronium ions will leave, these ion fluxes will occur spontaneously because pH gradients are not stable, and will collapse to the lowest energy level, meaning that a pH gradient across a semipermeable membrane will eventually collapse to yield the same pH on the inside and the outside of a membrane separating two compartments. In the example above, the pH will eventually become 9.0 on both sides of the compartment, and the biocide of the invention is designed to increase the rate of pH gradient collapse. A cell with a cytoplasmic pH of nine will die, because enzymes and proton gradients within the cell are function at a neutral pH of about 7.0 for most living organisms. Prolonged or severe alkalinization kills all known living cells. Even alkaline extremophiles deal with an alkaline external pH by using hydroxide pumping mechanisms, and even they cannot tolerate an alkaline internal pH, with the biocide killing even alkaline extremophiles by overwhelming the pumping mechanisms. In the germicide of the invention, the ammonia or other long chain detergent compound functions as a hydroxophore, and free base ammonia enters a cell in the neutral form and accepts a proton. The loss of a proton inside the cell is an event that corresponds exactly to the entry of a hydroxide anion because at a given pH, hydroxide anions and protons are linked by an equilibrium constant, it is impossible to change the concentration of hydroxide without altering the concentration of protons. In summary, the ammonia or other long chain detergent component results in accelerating the rate of alkalinization. A variety of other base materials to increase alkalinization may also be suitable.

Further examples of detergents that have been shown to be effective for use in the composition and method of the invention are set forth in Table 1 below, but it is understood that this list is not limited, and other detergents or agents providing the function of the detergent component may also be suitable.

TABLE 1

| | Number of | |
|---|---|---|
| Name Abbreviation | Carbons | Full Name |
| CTAC | 16 | Cetyl trimetylammonium chloride |
| CTAB | 16 | Cetyl trimethylammonium bromide |
| TTAC | 14 | Tetradecyl trimethyl ammonium |
| | | chloride |
| TTAB | 14 | Tetradecyl trimethyl ammonium |
| | | bromide |
| SDS | 12 | Sodium dodecyl sulfate |
| STS | 14 | Sodium tetradecyl sulfate |
| SCS | 16 | Sodium cetyl sulfate |
| SOS | 8 | Sodium octyl sulfate |
| HAD | 16 | Hexadecylamine |
| TDA | 14 | Tetradecylamine |
| CHAPS | XX | 3-[(3- |
| | | Cholamidopropyl)dimethylammonio]- |
| | | 1-propanesulfonate |
| DAPS | XX | 3-(decyldimethyl-ammonio) propane |
| | | sulfonate |

A second component, being a second hydroxophore is present in the biocide composition, such as hexadecylamine (HDA) or aniline as particular examples. The concentration of this component may be in the range of 5-40 weight percent for example, relative to the other components. Other concentrations may be suitable depending on the application, and as with the first component, again is generally in the mM range in a concentrate formulation that is dilutable for use. The HDA molecule for example has a long hydrophobic tail and an amine head group. The hydrophobic tail initially inserts into the plasma membrane of living cells and the amino head group remains in the water exposed to the external compartment. Compounds like HDA are known to flip-flop in the membrane so that the free amino group can travel from the external compartment to the internal compartment, but the molecule remains anchored in the plasma membrane. When flip-flop does occur, a hydroxophore action is evident, since a free ammonia group has just been transported from the external to the internal compartment. Note that this action is synergistic with the first component, such as free ammonia. A second damaging event conferred by HDA has to do with disruption of the plasma membrane caused by the insertion of the hydrophobic tail, HDA is essentially a detergent and will cause increased fluidity and disruption of the membrane, with such disruption leading to increased permeability of ammonia and an increase in flip-flop. Lastly once the HDA head group appears in the internal compartment it becomes protonated turning into ammonium. Effectively, this creates increased positive charge on the inner face of the membrane. Most plasma membranes in living cells maintain an external positive charge, HDA or other suitable materials therefore changes the membrane potential creating a positive charge on the inner leaflet of the phospholipids in the plasma membrane. All three actions of HDA are deleterious to living cells and synergistic with the first component such as ammonia. Alternatively, this component may be substitution of aniline for HAD, which also created a very lethal biocide and confirms a mechanism of action.

A third component in the biocide composition is an alcohol, such as ethanol. The concentration of this component may be in the range of 1-10 weight percent for example, relative to the other components. Other concentrations may be suitable depending on the application. Ethanol freely dissolves in the hydrophobic core of the plasma membrane and fluidizes that membrane. The fluidization caused by ethanol is synergistic with the fluidization effects of HDA. Ethanol also changes the polarity of water making the solvent much less polar, this circumstance causes more free base ammonia to appear since that decrease in polarity makes the ammonium ion much less stable and favors an increase in the percentage of amine free bases. Ethanol is therefore synergistic in causing the hydroxophore action to increase, and helps cause a rapid increase in alkalinization. Other alcohols in relatively low concentrations may also be used. For example, alcohols such as including but not limited to methanol, propanol, butanol, benzyl alcohol have been found to be effective in the composition and method of the invention.

The biocide composition of the invention greatly increases the toxicity by increasing the rate of alkalinization and can kill very quickly compared to other alkaline biocides. The biocide of the invention will also “auto-switch” off when the ethanol and ammonia evaporate, or it can manually be “switched off” by neutralizing it with non-toxic acetic or citric acid. Due to the synergistic effects of the components, the biocide results in rapid killing of the organisms, which is very desirable. For example, data indicate that the biocide achieves complete sterilization in a few minutes using a test bed organism, Vibrio fischeri. For a variety of applications, such as bio-terror attacks with pathogens, the “switchable” biocide/germicide of the invention would provide lethality to all known pathogens, while allowing the killing mechanism to be switched off after sterilization. The biocide uses alkalinity as the primary germicidal agent, and the lethality of the biocide can thus be instantly switched off by neutralization. At the same time, the individual components are individually benign, so that the separate liquid components can be stored for extended periods before use is desired, and pose no threat prior to mixing in just prior to use or in the field. The components will not significantly degrade upon long-term storage. Thus, the three components of the biocide composition when combined with alkalinity, these agents produce very effective biocides, but before mixing, the three components alone are relatively benign and pose little threat to humans, such as on skin contact. Also, due to the small concentrations, even upon contact with mucous membranes of the eyes, mouth or nose, though there may be slight tissue injury because those cells are permeable to the agents, the effects are minimized.

The proposed mechanism of action of the biocide includes a membrane fluidizing agent, which also helps generate a permeable hydroxophore in solution. A second agent disrupts cell membranes and inverts a membrane potential, while the third agent is a hydroxophore, and it accelerates the net transfer of hydroxide ions across the organism plasma membrane. The three components, when combined with an external alkaline pH gradient, generate a large alkaline flux which leads to cell death by rapidly raising the pH of the cellular cytoplasm. Notably, this killing mechanism can be easily “switched” off by neutralization to leave little to no residual toxicity after the biocide has served its purpose.

### Example 1

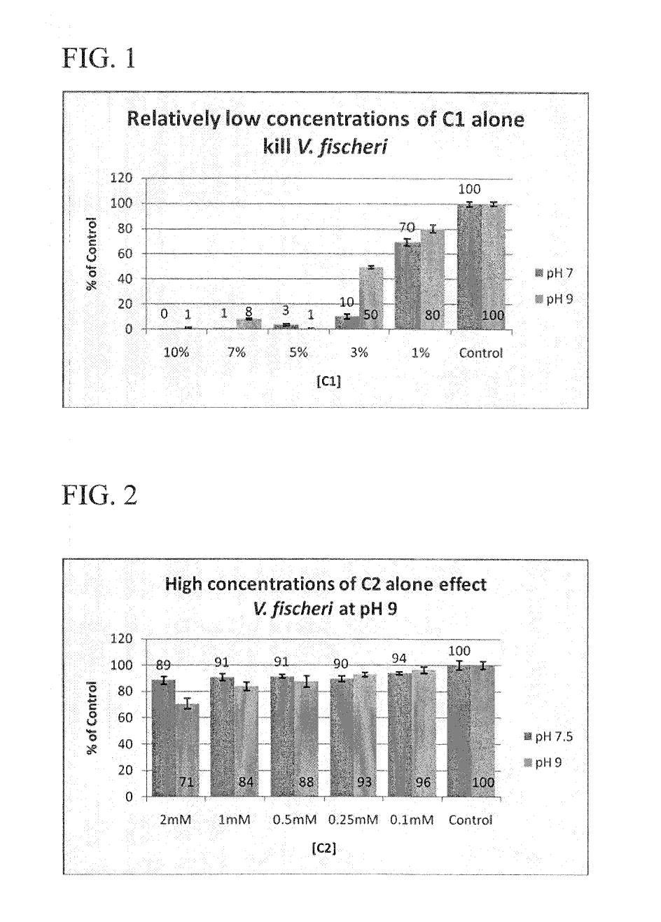

V. fischeri was grown overnight until the culture reached log phase and were brightly luminescent. Since bacterial luminescence is an ATP driven event, light emission is directly related to the metabolism and energy charge state of the organism. Lower luminescence levels correlate to lowered metabolism levels when compared to a non-treated control. It was previously established that when treated with known biocides, luminescence is abolished and does not recover. Samples at given concentrations were added to V. fischeri in a 24 well plate. A small amount was placed in a 96 well plate, agitated, and the luminescence was read in a TECAN well plate reader. For all figures, the total time period that V. fischeri was exposed to each biocide or component was between five and fifteen minutes. Results of testing show that Vibrio fischeri react to some of the individual components of the alkaline biocide in different ways. As shown in FIG. 1, the effect of ethanol at concentrations from 0%-10% on V. fischeri Luminescence are shown. The left side bars represent final pH of 7. The right side bars represent a final pH of 9. Low readings indicate killing. As seen in FIG. 1, V. fischeri is susceptible to ethanol; with even 1% concentrations show damage at pH 7 (and also at pH 9). V. fischeri treated with samples at a final pH of 9 showed higher luminescence than those treated with samples at a neutral pH. In other words, at a given concentration of ethanol, pH 7 seems to be slightly more damaging than the same concentration at pH 9. For example V. fischeri treated with 3% ethanol at pH 9 had a 40% higher luminescence reading than the same concentration at pH 7. This could be a result of stimulating the luminescence pathway through “irritation”. Mildly alkaline environments may not be harsh enough to damage the cell but may be irritating enough to enhance the luminescence pathway. It is important to note that while a luminescence of 0% of control is designated as “killed”, a luminescence higher than 100% of control is more difficult to interpret and may be due to the fact that the bacteria can generate a higher luminescence when stressed. From these test results, ethanol is the most lethal component of the alkaline biocide of the invention for V. fischeri. The purpose of this component is to fluidize the cell membrane to collapse the pH gradient. For other organisms, this component may be less effective than other of the components, wherein the combination of components synergistically provides for effective killing over a broad spectrum.

Turning to FIG. 2, the effect of the component HDA or a cetyl amine ranging from 0 mM-2 mM on V. fischeri luminescence was tested. The left side bars represent final pH of 7.5, while the right side bars represent a final pH of 9. FIG. 2 shows that HDA has little to no effect on V. fischeri at pH 7.5, however it does have a slight effect at higher concentrations at pH 9. A 29% decrease in luminescence is seen at 2 mM C2 at pH 9. At pH 7.5 2 mM C2 only shows an 11% decrease in luminescence. This does not follow the earlier trend of higher luminescence at higher pH. In the biocide, the ethanol and ammonia components are volatile. The HDA component has a very low solubility in water, but this is not a drawback because it is effective at low concentration (in combination with the ethanol and ammonia type components) and this minimizes any residual residue that would be left behind after using the biocide. The presence of ethanol or the like further increases the solubility level of the HAD or the like. For some applications, higher concentration of HDA or the like may be suitable, and once the three components are mixed, the solubility level of HDA will rise.

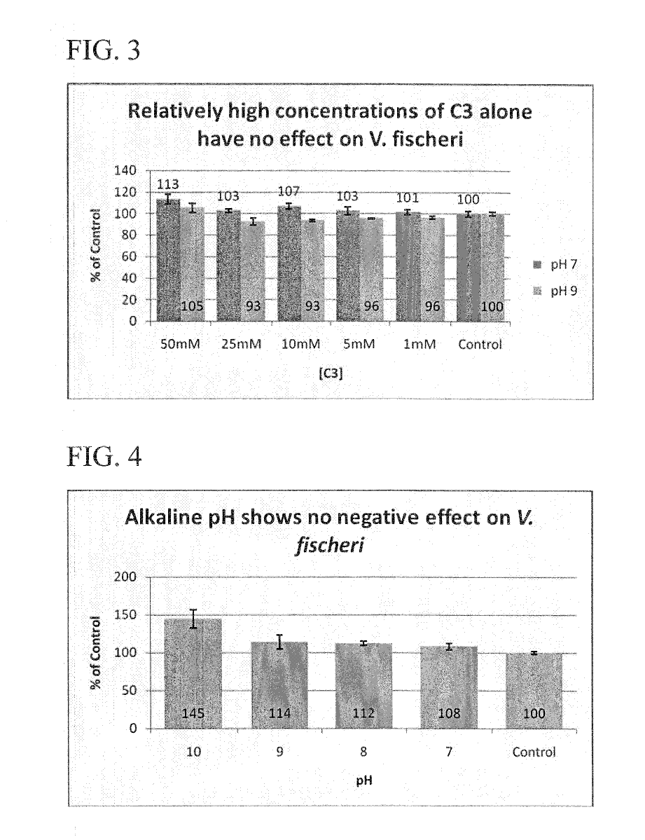

Turning to FIG. 3, the effect of ammonia ranging from 0 mM-50 mM on V. fischeri Luminescence is shown. The left side bars represent final pH of 7, while the right side bars represent a final pH of 9. FIG. 3 illustrates that the component ammonia by itself shows no difference from the control (pH adjusted H₂O) at either pH 7 or 9, meaning V. fischeri is not affected by ammonia at 50 mM concentration or lower at these pHs. This is an important finding because the flux of OH— into the cell is the major source of sequestration of H+ ions, which causes the interior cell cytoplasm to alkalinize and eventually leads to cell death. The flux of OH— into the cell is the major killing event induced by this component. Samples with very high ammonia concentrations are not killing the cell any faster than samples with little or no ammonia. This means that without the other components, in the case of V. fischeri, ammonia at these concentrations alone does not produce enough of an alkaline flux to damage the cell. The components work synergistically in order for the biocide to work properly. Samples with very high C3 concentrations are not killing the cell or sequestering H+ any faster than samples with little or no C3. This means that without the other components, in the case of V. fischeri, C3 alone does not produce enough of a hydrogen ion flux to damage the cell. The other components are necessary in order for the biocide to work properly.

Turning to FIG. 4, the effect of pH from 7-10 on V. fischeri Luminescence is shown. An external pH gradient drives an influx of OH⁻ into the intracellular environment and concomitantly creates a H⁺ gradient driving an H⁺ efflux, either pathway collapses the pH gradient and will alkalinize the cytoplasm, killing the bacterium. FIG. 4 shows that alkaline pH alone does not kill V. fischeri. All samples tested showed an unchanged or higher luminescence than the H₂O control and the untreated control. As noted previously, a higher luminescence is seen with increased alkalinity (see FIG. 1). An extracellular alkaline environment seems to increase the luminescence. Whether an increase in cellular metabolism is producing a higher number of luminescent molecules per cell, or there is simply a “mild “irritant” effect, or the V. fischeri thrive at a higher pH is not yet determined.

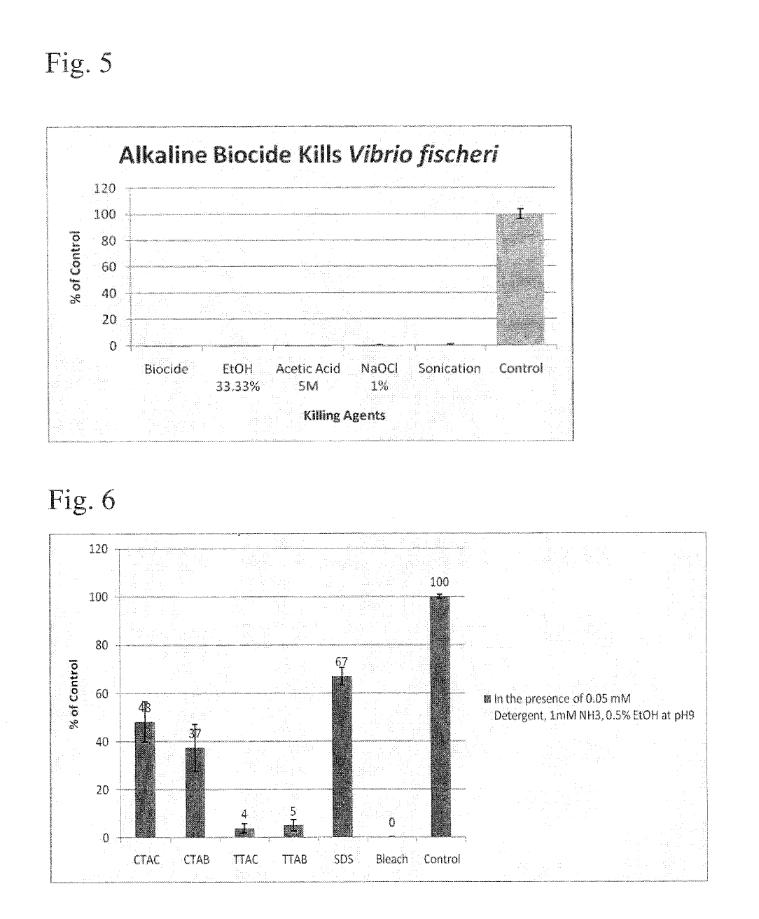

Turning to FIG. 5, the effect of various killing agents on V. fischeri Luminescence are shown. Samples are shown at their final concentrations. The biocide listed on the far left is the biocide according to the invention, with a combination of the three components as described above, at pH 9. As seen in FIG. 5, the alkaline biocide according to the invention (listed as biocide in FIG. 5) is completely lethal to V. fischeri along with the other very harsh sterilizing agents shown in the figure. The advantages of the multi-component biocide according to the invention, such as compared with these other harsh sterilizing agents are as follows. Extreme lethality is generated, with no pathogens remaining to cause infection. The biocide of the invention utilizes an inward flux of chemicals that immediately interferes with cell metabolism and viability. The multiple components and multiple mechanisms provided by the biocide of the invention achieve complete lethality, with the chemical flux generated being invariably lethal to V. fischeri. Accordingly, extrapolation indicates that the biocide would be similarly lethal to any other microbes or pathogens. The biocide thus has a broad spectrum of killing activity is desired, with an overall mechanism that will destroy any known (or newly created) pathogen. The biocide achieves rapid killing, which is very desirable. The data indicate that complete sterilization is achieved at least in about 5-15 minutes using the test bed organism, Vibrio fischeri. The biocide has a short persistence time, with no long term toxicity remaining. As described, each component in the multi-component water based system is relatively harmless but, when combined and diluted, produces a potent biocide. The biocide is switchable between being a highly effective killing agent, while allowing instant chemical neutralization as a switch to immediately deactivate the biocide/germicide. Further, as several of the components have high vapor pressures, evaporation of these components after deployment of the biocide provides an “auto-switch”, so that after sterilization, no long term toxicity can occur. The germicide also is inexpensive, portable, storable, safe and easy to use. The final concentration of the components is small and therefore, the composition is less harsh on the surfaces or materials it is used.

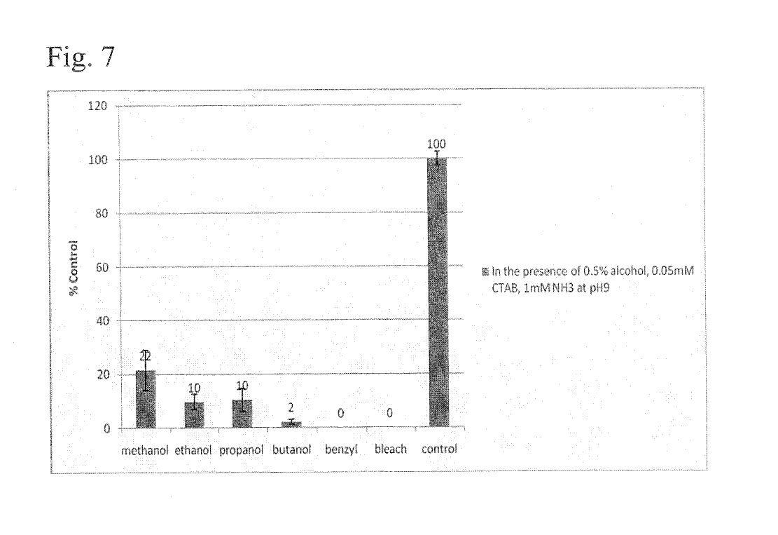

Turning to FIGS. 6 and 7, there is illustrated the principle that a wide variety of detergents or alcohols work as a component of the biocidal composition. In the first experiments shown in FIG. 6, the concentration of ammonia was held constant at 1 mM, while the ethanol concentration was held at 0.5% and the pH was adjusted to 9. In this example, the final concentrations in the biocide are 1 mM NH3, 0.5% EtOH, and 0.05 mM of detergent, and pH was adjusted to 9.0 with 1.0M sodium hydroxide. The type of detergent was then varied at a concentration of 0.05 mM. The detergents used in these examples were CTAC, CTAB, TTAC, TTAB and SDS. All of the detergents showed some degree of killing, with it being understood that the detergent concentration of 0.05 mM was very low. The use of very low detergent concentration was purposefully done in these examples in order to show variations in the killing power of the different detergents. If the detergent concentration was raised to 1 mM (which is still very dilute), all the detergents were found to kill effectively. Similarly, analogous experiments were conducted to show the killing power of various alcohols within a constant formulation. In the experiments shown in FIG. 7, the composition included an ammonia concentration that was held constant at 1 mM, a CTAB concentration of 0.05 mM and the pH was adjusted to 9. In this example, the final concentration in the biocide are 1 mM NH3, 0.05 mM CTAB, and 0.5% of alcohol, and pH was adjusted to 9.0 with 1.0M sodium hydroxide. The type of alcohols were then varied at a concentration of 0.5%. The alcohols used were methanol, ethanol, propanol, butanol and benzyl alcohol. All of the alcohols showed some degree of killing, with it being understood that the alcohol concentration of 0.5% was very low. The low concentration of alcohol was purposefully done in order to show variations in the killing power of the alcohols. If the alcohol concentration was raised to 1% (which is still very dilute), all the alcohols were found to kill effectively.

In the composition, the particular components are only examples, and other similar components are contemplated. The components work together to greatly increase killing efficacy. The components each have mechanisms, that work synergistically together to increase the biocidal activity. For example, ethanol or the like suppresses ionization, such that the ammonia tends to exist in neutral form that allows the ammonia (or the like) to enter the cell very rapidly when neutral ammonia (or the like) builds up around the pathogen. The component of ethanol, or the like, suppresses ammonium ion creation and creates more free ammonia (or the like). Further, the ethanol or the like fluidizes the cell membrane to increase the flux of ammonia into the microbes or pathogens. The HDA or the like component also assists by reversing the membrane potential, and fluidizes the membrane and carry a free ammonia into the cell and take a positive charge from the outside of the membrane to the inside. Flipping the electrical potential of the membrane also causes problems in cell function to facilitate killing efficacy.

Further, the biocide composition chemicals involved are very inexpensive, and the components are stable and do not decompose during long term storage. A high initial concentration of each component enables portability when water is available. Mixing the components immediately creates the potent germicide. Spraying and soaking are acceptable modes of application. Thus, the composition may be stored as the individual components in a suitable container or storage system, until use of the biocide/germicide is desired, and then mixed and deployed as needed. As merely examples, the components may be stored in a container and separated by a frangible material until use is desired, wherein the frangible material can then be ruptured to cause mixing of the components for use. Alternatively, the components could be stored separately and combined and mixed at a spray nozzle for example. Any other suitable arrangement for selectively storing the components and subsequently mixing them for use are contemplated. Further, the components may be mixed and stored in a container for use if desired, such as via a spray bottle or the like.

For example, an application of the biocide/germicide may relate to cleaning and disinfecting of household surfaces, such as kitchen counters, bathroom surfaces, walls, floors, etc., similar to many household types of cleaning/disinfecting agents currently in the market. Other areas, such as in hospitals, ambulances, airplanes or a variety of other environments and applications are also suitably decontaminated using the composition of the invention. Cleaning of industrial food processing equipment or other industrial machines may also be possible. The advantages of the present invention allow for highly effective disinfection of such hard or other surfaces, while not leaving any lasting toxicity or unwanted residue, and not leaving any harsh chemicals that could affect people adversely. The composition may be used in a manner similar to other such cleaning/disinfecting products by mixing with water and applying to surfaces via wiping or the like, or by spraying or other suitable means.

The composition could also be used in the disinfection/decontamination of water or other fluids, such as in a water treatment facility. For example, water to be treated may be contained in a tank or the like, and a suitable amount of the composition of the invention may be introduced into the water. Mixing of the composition with the body of water may allow dispersion of the biocide to treat the totality of the water. Mixing or bubbling of the water after some dwell time may also allow the volatile components to evaporate more quickly to switch off the disinfection activity and leave the water decontaminated. Such a process could also be used in other applications such as fish, shrimp or the like farms, where fish or shrimp are grown in a pond or the like. In such situations, it is possible for the pond to become contaminated with bacteria or viruses for example, that can decimate the animal population. Further, in many such environments, it is possible that water from other sources, such as a nearby body of water or bay, comingles into the pond, either potentially bringing in pathogens to the pond water, or allowing escape of contaminated pond water into such other bodies of water. Such problems not only cause significant damage to the farming activity, but any such releases can also impact wildlife or vegetation in the other bodies of water. The disinfecting composition of the invention may be used to sterilize water coming into and out of such ponds or the like. Other disinfectants, such as chlorine cannot be used because they introduce halogenated compounds into the environment. In an example, water supplied to or from such a pond could be first sent to a holding pond to clean/decontaminate the water coming in or to be released, with the biocide composition introduced into the holding pond for treatment of the water. Upon being decontaminated, the composition may then be switched off and the decontaminated water introduced into or released from the pond. As an example, the switching off of the biocidal activity of the composition may be performed by air bubbling in the holding tank which accelerates removal of the volatile components by evaporation. Testing of the pH level of the water in the holding tank will indicate when it is switched off, such as at around a pH of 7. Other water treatment applications are contemplated, such as treatment of ballast water from vessels for example.

As another example, the biocidal composition may be used to remediate bio-terror attacks with pathogens, or spills or other releases of pathogens, the biocide of the invention may be deployed over large areas for sterilizing the pathogens quickly, and then the lethality of the biocide could be instantly switched off by neutralization. The components may be stored in large containers and individually pumped to a spray nozzle where they can be mixed with water for deployment. Alternatively, the components could be mixed in the field and deployed by spraying or soaking.

Based upon the foregoing disclosure, it should now be apparent that the methods of producing biocidal/germicidal compositions, methods and devices provide a highly effective system for decontamination of surfaces, water or other fluids, and many other applications that are too numerous to describe. The components used in the composition can be modified while still performing the synergistic functions with one another. Example apparatus for the deployment of the decontamination composition are likewise too numerous to describe, as a wide variety of devices are envisioned. It is, therefore, to be understood that any variations evident fall within the scope of the claimed invention and thus, the selection of specific component elements can be determined without departing from the spirit of the invention herein disclosed and described.

What is claimed is:

1. A biocidal composition comprising:
an amount of at least one first component designed to suppress ionization and generate a permeable hydroxophore in a solution of components in the composition,
an amount of at least one second component designed to accelerate the net transfer of hydroxide ions across the organism plasma membrane of the microbe or pathogen,
an amount of at least one third component designed to disrupt cell membranes and invert a membrane potential,
wherein at least one of the components causes fluidization of a cell membrane of a microbe or pathogen,
wherein the at least three components, when combined with an external alkaline pH gradient, generate an alkaline flux which leads to cell death by rapidly raising the pH of the cellular cytoplasm.

2. The composition of claim 1, wherein the killing mechanisms of the composition are selectively switched off by neutralization.

3. The composition of claim 1, wherein the composition leaves little to no residual toxicity upon neutralization of the composition.

4. The composition of claim 3, wherein neutralization occurs by evaporation of one of more of the components or by the application of a neutralizing agent.

5. The composition of claim 1, wherein the at least one first component is a long chain detergent material in a concentration of mM range.

6. The composition of claim 1, wherein the at least one second component is a hydroxophore material in a concentration of mM range.

7. The composition of claim 1, wherein the at least one third component is an alcohol in a concentration of mM range.

8. The composition of claim 1, wherein the concentration of the at least one first component is in the range of about 5-40 weight percent relative to the at least three components in the composition, the at least one second component is in the range of about 5-40 weight percent relative to the at least three components in the composition, and the at least one third component is in the range of about 1-10 weight percent relative to the at least three components in the composition.

9. A process for preparing a biocidal composition, the process comprising:
providing an amount of at least one first component designed to suppress ionization of components in the composition, an amount of at least one second component designed to create an alkaline environment of non-ionized constituents around the cell membrane of the microbe or pathogen, and an amount of at least one third component designed to reverse the cell membrane potential, with each of the components stored separately, and
mixing of the components for deployment to decontaminate surfaces or areas.

10. The process of claim 9, wherein the at least one first component is a long chain detergent material in a concentration of mM range.

11. The process of claim 10, wherein the at least the at least one first component is a long chain detergent.

12. The process of claim 9, wherein the at least one second component is a hydroxophore material in a concentration of mM range.

13. The process of claim 9, wherein the at least one third component is an alcohol in a concentration of mM range.

14. A biocidal composition comprising:
at least an amount of a first component being a detergent material in a concentration of mM range,
at least an amount of a second component being a hydroxophore material in a concentration of mM range,
at least an amount of a third component being an alcohol in a concentration of mM range,
wherein the at least three components, when combined with an external alkaline pH gradient, act as a biocidal agent.

15. The composition of claim 14, wherein the first component is a long chain detergent material.

16. The composition of claim 14, wherein the killing mechanisms of the composition are selectively switched off by neutralization.

17. The composition of claim 16, wherein neutralization occurs by evaporation of one of more of the components or by the application of a neutralizing agent.

18. The composition of claim 16, wherein the composition leaves little to no residual toxicity upon neutralization of the composition.

19. The composition of claim 14, wherein the detergent material is selected from the group consisting of ammonia, cetyl trimetylammonium chloride, cetyl trimethylammonium bromide, tetradecyl trimethyl ammonium chloride, tetradecyl trimethyl ammonium bromide, sodium dodecyl sulfate, sodium tetradecyl sulfate, sodium cetyl sulfate, sodium octyl sulfate, hexadecylamine, tetradecylamine, 3-[(3-Cholamidopropyl)dimethylammonio]-1-propanesulfonate, 3-(decyldimethyl-ammonio) propane sulfonate or combinations thereof.

20. The composition of claim 14, wherein the alcohol is selected from the group consisting of methanol, ethanol, propanol, butanol, benzyl alcohol or combinations thereof.
